(19) United States
(12) Patent Application Publication
(10) Pub. No.: US 2005/0245164 A1
(43) Pub. Date: Nov. 3, 2005

(54) Fire blocker fiber composition, high loft web structures, and articles made therefrom

(76) Inventors: Arun Pal Aneja, Greenville, NC (US); Laurence N. Bascom, Amelia, VA (US); Herman Hans Forsten, Williamsburg, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/836,662

(22) Filed: Apr. 30, 2004

(51) Int. Cl. D03D 15/00; D03D 25/00; D04H 1/00; D04H 3/00; D04H 5/00; D04H 13/00; D02G 3/00; B32B 5/26; B32B 5/06; B27N 9/00

(52) U.S. Cl. 442/414; 442/327; 442/381; 442/389; 442/415; 428/920; 428/921

(57) ABSTRACT

The present invention is directed to a fiber composition useful for fire blocking; a high loft web structure made from such fiber composition and a process for making such web structure; and a fire blocked article such as a mattress or furniture incorporating such high loft web structure and a method for fireblocking said articles; the fiber composition comprising (a) 1 to 20 parts by weight p-aramid fibers, (b) 20 to 60 parts by weight regenerated cellulose fibers containing silicic acid, and (c) 10 to 60 parts by weight polyester fibers, (d) up to 20 parts by weight binder material wherein the total of (a), (b), (c) and (d) is on a basis of 100 parts by weight.

### BACKGROUND

1. Field of the Invention

The present invention is directed to a fiber composition useful for fire blocking; a high loft web structure made from such fiber composition and a process for making such web structure; and a fire blocked article such as a mattress or furniture incorporating such web structure and a method for fireblocking said article.

2. Description of Related Art

California has mandated that bedding and furniture must have improved fire-retardant characteristics, and other states are expected to implement similar standards. In addition, the United States is moving toward a federal standard for mattress flammability based on Technical Bulletin 603 of the State of California burn test. Existing mattresses containing only a foam/polyester layer for cushioning will be unable to meet the stringent requirements of fire retardancy.

U.S. Pat. No. 5,645,296 discloses flexible fire and heat resistant materials formed from an intimate mixture of organic intumescent filler and organic fibers. WO 03/023108 A1 discloses a nonwoven high loft fire barrier preferably containing a combination of melamine fibers, viscose rayon fibers, fibers from polymers made from halogenated monomers and low melt binder fibers in a crosslapped structure configuration. U.S. Pat. No. 6,602,581 discloses corrugated vertically folded filling structures.

Despite the disclosures in these publications there remains a need for an improved barrier to the propagation of fire and flame that can be employed in mattresses, upholstery and furniture that does not detract from the comfort, cushioning, and/or resiliency of such items.

### SUMMARY OF THE INVENTION

This invention relates to a fiber composition useful for fireblocking, comprising 1 to 20 parts by weight p-aramid fibers, 20 to 60 parts by weight regenerated cellulose fibers containing silicic acid, 10 to 60 parts by weight polyester fibers, and up to 20 parts by weight binder material wherein the total of the fibers and binder material is on a basis of 100 parts by weight.

This invention also relates to a high loft web structure, comprising 1 to 20 parts by weight p-aramid fibers, 20 to 60 parts by weight regenerated cellulosic fiber that retains at least 10 percent of its fiber weight when heated in air to 700° C. at a rate of 20 degrees C. per minute, 10 to 60 parts by weight polyester fibers, and up to 20 parts by weight binder fibers wherein the total of fibers and binder material is on a basis of 100 parts by weight.

This invention further relates to a process for making a high-loft web structure, comprising the steps of:
(a) forming a mixture of 1 to 20 parts by weight p-aramid fiber, 20 to 60 parts by weight regenerated cellulosic fiber that retains at least 10 percent of its fiber weight when heated in air to 700° C. at a rate of 20 degrees C. per minute, 10 to 60 parts by weight polyester fiber, and up to 20 parts by weight binder material, wherein the total of these fibers and binder material is on a basis of 100 parts by weight,
(b) blending the mixture to form a uniform fiber composition,
(c) carding the uniform fiber composition to form a web,
(d) converting the web into a high-loft web structure having a lengthwise rectangular cross section with parallel ridges and grooves, and
(e) activating the binder material with heat to set the high loft web structure.

One embodiment of this process for making a high-loft web structure comprises the steps of:
(a) forming a mixture of 1 to 20 parts by weight p-aramid fiber, 20 to 60 parts by weight regenerated cellulosic fiber that retains at least 10 percent of its fiber weight when heated in air to 700° C. at a rate of 20 degrees C. per minute, and 10 to 60 parts by weight polyester fiber,
(b) blending the mixture to form a uniform fiber composition,
(c) carding the uniform fiber composition to form a web,
(d) contacting the web with up to 20 parts by weight a binder material,
(e) converting the web into a high loft web structure having a lengthwise rectangular cross section with parallel ridges and grooves, and
(f) activating the binder material with heat to set the high loft web structure,
   wherein the total of the fibers and binder material is on a basis of 100 parts by weight.

This invention also relates to a fireblocked mattress, comprising as one component of the mattress a high loft web structure, the web structure comprising 1 to 20 parts by weight p-aramid fiber, 20 to 60 parts by weight regenerated cellulosic fiber that retains at least 10 percent of its fiber weight when heated in air to 700° C. at a rate of 20 degrees C. per minute, 10 to 60 parts by weight polyester fiber, and up to 20 parts by weight binder material wherein the total of the fibers and binder material is on a basis of 100 parts by weight.

This invention further relates to a process for fireblocking a mattress, comprising incorporating into a mattress a high loft web structure, the web structure comprising 1 to 20 parts by weight p-aramid fibers, 20 to 60 parts by weight regenerated cellulosic fiber that retains at least 10 percent of its fiber weight when heated in air to 700° C. at a rate of 20 degrees C. per minute, 10 to 60 parts by weight polyester fiber, and up to 20 parts by weight binder material, wherein the total of the fibers and binder material is on a basis of 100 parts by weight.

### BRIEF DESCRIPTION OF THE DRAWINGS

FIG. 1 is a photographic representation of a preferred vertically-stacked high loft web structure.

FIG. 2 is a perspective view of a preferred vertically-stacked high loft web structure.

FIG. 3 is a perspective view of a typical mattress quilt incorporating a preferred vertically-stacked high loft web structure.

FIG. 4 is a sectional side elevation view of a mattress quilt panel composite fabric incorporating a preferred vertically-stacked high loft web structure.

### DETAILS OF THE INVENTION

Fiber Composition

This invention relates to fiber composition useful in a uniform high-loft web structure for use as a fire blocking layer in mattresses, furniture, and other articles. This fire-blocking character of the high loft web structure is dependent on a fiber composition that is comprised, based on a total of 100 parts, of 1 to 20 parts by weight of para-aramid fibers, 20 to 60 parts by weight regenerated cellulosic fibers containing silicic acid, 10 to 60 parts by weight polyester fibers, and up to 20 parts by weight binder material.

Preferably, these fibers are carded staple fibers having a linear density of about 0.55 to about 110 dtex per filament (0.5 to 100 denier per filament), preferably 0.88 to 56 dtex/filament (0.8 to 50 denier/filament) with the linear density range of about 1 to 33 dtex/filament (0.9 to 30 denier/filament) being most preferred. The fibers generally have a cut length of about 1.3 cm to 10.2 cm (0.5 to 4 in) and a preferred crimp frequency of about 2.4 to 5.9 crimps per cm (6 to about 15 crimps/inch).

The fiber composition of this invention contains para-aramid fiber. Such fiber retains 90 percent of its fiber weight when heated in air to 500° C. at a rate of 20 degrees C. per minute. Such fibers are also fire resistant, meaning the fiber or a fabric made from the fiber has a Limiting Oxygen Index (LOI) such that it will not support a flame in air, the preferred LOI range being greater than 26. When the fiber composition of this invention is incorporated into a high loft web structure, it is believed to help prevent shrinkage and thereby provide stability to the structure in flame. Up to 20 parts by weight of para-aramid fiber is preferred for this invention; if greater than 20 parts by weight are used in structures made from the fiber composition, additional fire resistance is obtained at the expense of other structure properties.

As employed herein, the term “aramid” means a polyamide wherein at least 85% of the amide (—CONH—) linkages are attached directly to two aromatic rings. “Para-aramid” fibers have para linkages to the aromatic rings and “meta-aramid” fibers have meta linkages. Additives can be used with the aramid and, up to as much as 10 percent by weight of other polymeric material can be blended with the aramid or that copolymers can be used having as much as 10 percent of other diamine substituted for the diamine of the aramid or as much as 10 percent of other diacid chloride substituted for the diacid chloride of the aramid. Methods for making para-aramid fibers useful in this invention are generally disclosed in, for example, U.S. Pat. Nos. 3,869,430; 3,869,429; and 3,767,756. The preferred para-aramid fiber for this invention is poly(paraphenylene terephthalamide) fiber. Such fiber is commercially known under the trademark KEVLAR® by E. I. du Pont de Nemours and Company of Wilmington, Del. (hereinafter “DuPont”) KEVLAR® Type 970 fiber, having a single filament linear density of 2.5 dtex/filament (2.25 denier/filament) and an average cut length of 4.8 cm (1.9 in) is the preferred KEVLAR® fiber.

The cellulosic fiber used in the fiber composition of this invention is regenerated cellulosic fiber that retains at least 10 percent of its weight when heated in air to 700° C. at a rate of 20 degrees C. per minute. Such fibers, when incorporated into web structures are high char formers when burned, providing excellent coverage and barrier to flame and fire. It is believed at least 20 parts by weight of such fibers are necessary to provide adequate char and coverage in web structures; above 60 parts by weight it is believed the high amount of char causes the web structure to become increasingly brittle and structure performance suffers.

The preferred cellulose fibers have at least 10 percent by weight inorganic compounds incorporated into the fibers. Such fiber, and methods for making such fibers, are generally disclosed in U.S. Pat. No. 3,565,749 and British Pat. No. GB 1,064,271. A preferred cellulosic fiber for this invention is a viscose fiber containing silicon dioxide in the form of a polysilicic acid with aluminum silicate sites. Such fibers, and methods for making such fibers are generally disclosed in U.S. Pat. No. 5,417,752 and PCT Pat. Appl. WO 9217629. Viscose fiber containing silicic acid and having approximately 31 (+/−3) percent inorganic material is sold under the trademark VISIL® by Sateri Oy Company of Valkeakoski, Finland. VISIL® Type33AP fiber having a linear density of 1.7 dtex/filament (1.5 denier/filament) and an average cut length of 4.1 cm (1.6 in) is the preferred VISIL® fiber. The addition of inorganic material gives this fiber adequate fire-retardancy without the need for additional treatment with additional fire-retardant additives or topically-applied fire retardant compounds.

The fiber composition of this invention also contains at least 10 parts by weight of polyester fiber to provide resilience to web structures made from the fiber composition. If more than 60 parts by weight polyester fibers are used, it is believed the composition becomes too flammable to be used in fire blockers. The polyester fiber used in the fiber composition of this invention are well known in the art and can be obtained from many sources. The preferred polyester fiber is made from poly(ethylene terephthalate)polymer. Other polyesters, however, may be used, such as homopolymers, copolymers, terpolymers, and blends etc., of polyester polymers and monomers of poly(propylene terephthalate, poly(butylenes terephthalate), poly(1,4-cyclohexylene-dimethylene terephthalate) and copolymers and mixtures thereof. The preferred poly(ethylene terephthalate) fiber is commercially available from Invista, Inc. of Wilmington, Del. under the trademark DACRON® Type 808 single hole hollow fiber having a linear density of 7.2 dtex/filament (6.5 denier/filament) having a cut length of 3.8 cm (1.5 in).

The fiber composition of this invention also includes a binder material present in an amount of up to 20 parts by weight of the total amount of para-aramid fiber, regenerated cellulosic fiber, polyester fiber, and binder material in the fiber composition. While more than 20 parts by weight binder may be used, it is believed that additional binder does not appreciably contribute to the invention and could possibly detract from the properties of web structures made from the composition. The binder can be a fiber or can be either a powder or a liquid applied to the fibers. The chemical composition of the binder is not especially critical as long as binder serves its appropriate function, that is, of holding together or providing a degree of integrity or rigidity to web structures made from the fiber composition.

The preferred binder material is a binder fiber that is activated by the application of heat. Such binder fibers are typically made from a thermoplastic material that flows at a temperature that is lower (i.e., has a softening point lower) than the softening point of any of the other staple fibers in the fiber blend. Sheath/core bicomponent fibers are preferred as binder fibers, especially bicomponent binder fibers having a core of polyester homopolymer and a sheath of copolyester that is a binder material, such as are commonly available from Unitika Co., Japan (e.g., sold under the trademark MELTY®). Useful types of binder fibers can include those made from polypropylene, polyethylene, or polyester polymers or copolymers, the fibers containing only that polymer or copolymer, or as a bicomponent fiber in side-by-side or sheath/core configuration.

As an optional and additional component, the fiber composition of this invention can have up to 20 parts by weight of meta-aramid or modacrylic fibers. Meta-aramid fibers shrink more in flame than para-aramid fibers, however they are generally lower in cost while having fire resistance similar to para-aramid fibers. Therefore, meta-aramid fibers can be used in place of some of the para-aramid fibers in fiber compositions for those fire blocking structures that can withstand a higher degree of shrinkage in flame.

The preferred meta-aramid fiber is poly(metaphenylene isophthalamide) fiber, an example of which is commercially available from DuPont under the trademark NOMEX®. NOMEX® Type 450 fiber, having a single filament linear density of 1.7 dtex/filament (1.5 denier/filament) and an average cut length of 3.8 cm (1.5 in) is the preferred NOMEX® fiber.

Modacrylic fiber releases flame-suppressing halogen-containing gases (typically chlorine-containing gases) when burned. By modacrylic fiber it is meant acrylic synthetic fiber made from a polymer comprising primarily acrylonitrile. Modacrylics are generally made from a copolymer having less than about 85% but at least 35% polyacrylonitrile and other polymers such as vinyl chloride, vinylidene chloride, vinyl bromide or vinylidene bromide. Preferably, the polymer is a copolymer comprising 30 to 70 weight percent of an acrylonitrile and 70 to 30 weight percent of a halogen-containing vinyl monomer. The halogen-containing vinyl monomer is at least one monomer selected, for example, from vinyl chloride, vinylidene chloride, vinyl bromide, vinylidene bromide, etc. Examples of copolymerizable vinyl monomers are acrylic acid, methacrylic acid, salts or esters of such acids, acyrlamide, methylacrylamide, vinyl acetate, etc.

Preferred modacrylic fibers of this invention are copolymers of acrylonitrile combined with vinylidene chloride, the copolymer having in addition an antimony oxide or antimony oxides for improved fire retardancy. Such useful modacrylic fibers include, but are not limited to, fibers disclosed in U.S. Pat. No. 3,193,602 having 2 weight percent antimony trioxide, fibers disclosed in U.S. Pat. No. 3,748,302 made with various antimony oxides that are present in an amount of at least 2 weight percent and preferably not greater than 8 weight percent, and fibers disclosed in U.S. Pat. Nos. 5,208,105 & 5,506,042 having 8 to 40 weight percent of an antimony compound.

The preferred modacrylic fiber is available commercially under the trademark of PROTEX C from Kaneka America Corporation, New York, N.Y. The preferred PROTEX C fiber is a fiber made from a copolymer of polyacrylonitrile and vinylidene chloride with 5 to 15% antimony having a linear density of 1.7 dtex/filament (1.5 denier/filament) and a cut length of 5.1 cm (2 in), although fibers having less antimony oxide, in the range of less than 5 weight percent can also be used.

The fiber composition of this invention has, based on a total of 100 parts, 1 to 20 parts by weight of para-aramid fibers, 20 to 60 parts by weight regenerated cellulosic fibers containing silicic acid, 10 to 60 parts by weight polyester fibers, and up to 20 parts by weight binder material. A preferred fiber blend composition is 1 to 10 parts by weight para-aramid, 30 to 50 parts by weight cellulosic fibers containing silicic acid, 30 to 60 parts by weight polyethylene terephthalate fibers, 10-20 parts by weight polyester binder fiber, and up to 10 parts by weight meta-aramid fiber.

High-Loft Web Structures

This invention also relates to a high loft web structure, comprising 1 to 0.20 parts by weight p-aramid fibers, 20 to 60 parts by weight regenerated cellulosic fiber that retains at least 10 percent of its fiber weight when heated in air to 700° C. at a rate of 20 degrees C. per minute, 10 to 60 parts by weight polyester fibers, and up to 20 parts by weight binder fibers wherein the total of fibers and binder material is on a basis of 100 parts by weight.

The high-loft web structure of the present invention has for cushioning and resilience an areal density of 100 to 510 grams/square meter (3 to 15 ounces/square yard) preferably 170 to 340 g/m² (5 to 10 oz/yd²), and an average height or thickness of 0.64 to 5.1 centimeters (0.25 to 2 inches), preferably 0.64 to 2.54 cm (0.25 to 1 inches). In addition, it is believed that the resilient high-loft web structure of this invention must have an areal density of at least 100 g/m² (3 oz/yd²) to function adequately as a fire blocker, while little additional fire blocking is expected from web structures having an areal density of greater than 510 g/m² (15 oz/yd²) that are made from the fiber compositions disclosed herein.

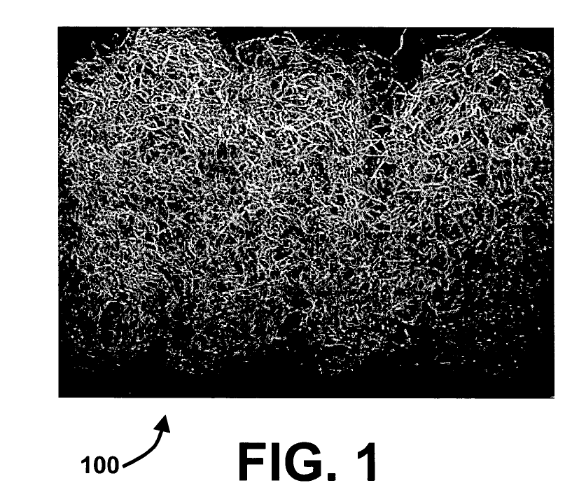

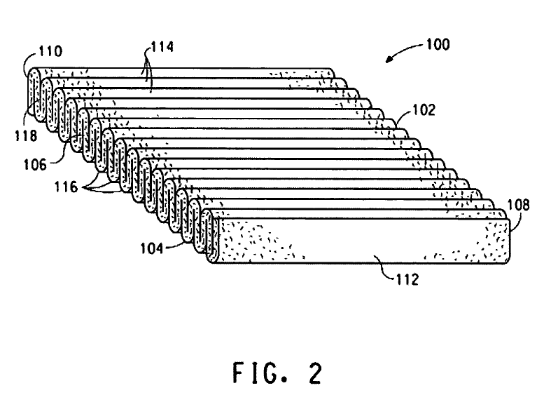

The preferred high loft web structure is a uniform corrugated or vertically-stacked web structure 100 as shown by the photographic representation in FIG. 1. The general type of such preferred corrugated or vertically-stacked web structures, and typical processes for making such structures, are disclosed in U.S. Pat. No. 6,602,581. A perspective view of the vertically stacked web structure is shown in FIG. 2. The vertically-stacked structure has an upper surface 102 and a lower surface 104, a first side wall 106 and a second side wall 108, and first and second end walls 110 and 112. The preferred vertically-stacked web structure has an essentially lengthwise rectangular cross section and comprises a plurality of parallel continuous alternating ridges (“peaks”) 114 and grooves (“valleys”) 116 of approximately equal spacing. In addition, the vertically stacked structure comprises a plurality of parallel aligned pleats or vertical stackings 118 that are arranged in accordion-like fashion and which extend in alternately different directions between each peak and each valley. The parallel aligned pleats may be interconnected by protruding fibers of the adjacent pleats. The upper surface of the structure is formed by the peaks, while the lower surface is formed by the valleys. The side walls 106, 108 are formed by the ends of the pleats, and the end walls 110 and 112 are formed by the last pleats of the structure. The peaks, valleys, and pleats can have any of the shapes disclosed in U.S. Pat. No. 6,602,581, incorporated herein by reference.

Vertically-stacked high-loft web structures are preferred, since in such structures the pleats cause a majority of the fibers to be oriented generally parallel to the impinging flame, which is believed to make such structures more efficient fire blockers than, say, cross-lapped structures where the fiber is generally perpendicular to impinging flames.

Process for Making High-Loft Web Structure

The preferred process for making high-loft web structures having a vertically stacked structure comprises the steps of:
(a) forming a mixture of 1 to 20 parts by weight p-aramid fiber, 20 to 60 parts by weight regenerated cellulosic fiber that retains at least 10 percent of its fiber weight when heated in air to 700° C. at a rate of 20 degrees C. per minute, 10 to 60 parts by weight polyester fiber, and up to 20 parts by weight
(b) binder material, wherein the total of these fibers and binder material is on a basis of 100 parts by weight,
(b) blending the mixture to form a uniform fiber composition,
(c) carding the uniform fiber composition to form a web,
(d) converting the web into a high loft web structure having a lengthwise rectangular cross section with parallel ridges and grooves, and
(e) activating the binder material with heat to set the high loft web structure.

The fiber mixture is normally achieved by opening and mixing crimped staple fiber obtained from bales by the use of conventional fiber opening equipment, such as a picker. Preferably, binder fiber is included in this mixture. The fiber is then blended using, for example, an air-conveyed blender to form a uniform fiber composition. The fiber composition is then-typically fed to equipment for forming a web, such as a card. The formed web is then formed into a high-loft web structure by the use of crosslapping, vertically pleating, or other processes that can achieve the desired structure. The high loft web structure is then set by applying heat to the web structure, preferably by use of a heated oven, to activate the binder material in the web structure.

An alternate process for making high-loft web structures having a vertically stacked structure comprises the steps of:
(a) forming a mixture of 1 to 20 parts by weight p-aramid fiber, 20 to 60 parts by weight regenerated cellulosic fiber that retains at least 10 percent of its fiber weight when heated in air to 700° C. at a rate of 20 degrees C. per minute, and 10 to 60 parts by weight polyester fiber,
(b) blending the mixture to form a uniform fiber composition,
(c) carding the uniform fiber composition to form a web,
(d) contacting the web with up to 20 parts by weight a binder material,
(e) converting the web into a high loft web structure having a lengthwise rectangular cross section with parallel ridges and grooves, and
(f) activating the binder material with heat to set the high loft web structure,
   wherein the total of the fibers and binder material is on a basis of 100 parts by weight. This process is preferred when the binder material is in powder or liquid form.

While not as preferred, a high-loft web structure having a relatively open structure can be made by other methods known in the art for making high-loft web structures. These include crosslapping an air-laid or otherwise formed web on a belt or apron as is well known in the art and generally disclosed in U.S. Pat. No. 3,558,029 to Manns; U.S. Pat. No. 3,877,628 to Asselin et al.; U.S. Pat. No. 4,984,772 to Freund; U.S. Pat. No. 6,195,844 to Jourde et al., and British Patent Number 1,527,230 to Jowett.

Fire Blocked Articles

This invention also includes a fire blocked article comprising the high loft web structure described herein. Preferably, this article is a mattress wherein one component of the mattress is a high loft web structure, the web structure comprising 1 to 20 parts by weight p-aramid fiber, 20 to 60 parts by weight regenerated cellulosic fiber that retains at least 10 percent of its fiber weight when heated in air to 700° C. at a rate of 20 degrees C. per minute, 10 to 60 parts by weight polyester fiber, and up to 20 parts by weight binder material wherein the total of the fibers and binder material is on a basis of 100 parts by weight.

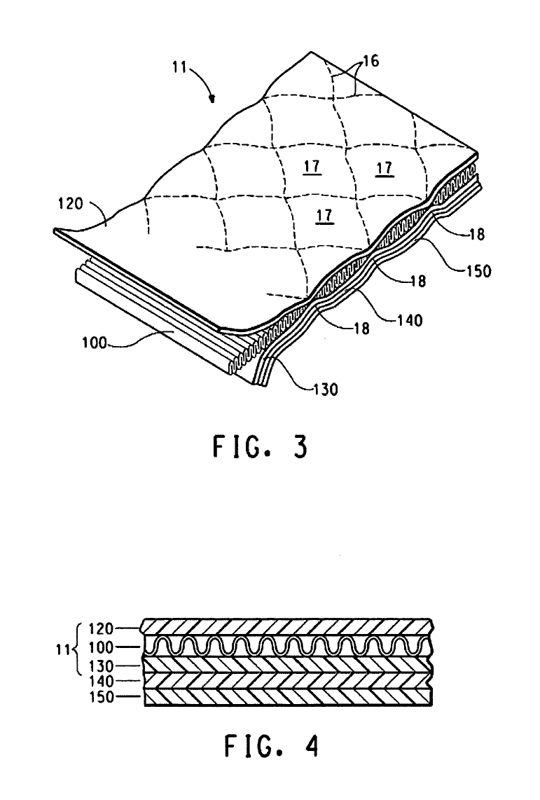

While not intended to be limiting, FIG. 3 is a perspective view and FIG. 4 is an enlarged sectional side elevation view of a typical mattress quilt panel, incorporating the high loft web structure of this invention that can be used in a mattress for fire blocking. The mattress quilt panel 11 can be formed by combining layers of ticking fabric 120, high-loft web structure layer 100 for fire blocking, and one or more layers of thermoplastic batting 130 and/or foam 140, followed by scrim cloth 150, which is used on the side of the mattress quilt that will be facing the mattress internals.

The ticking fabric 120 is normally a very durable woven or knit fabric utilizing any number of weaves, and tends to have basis weights in the range of 2 to 8 ounces per square yard (68 to 271 grams per square meter). Typical ticking fabrics may contain but are not limited to cotton, polyester fibers, or rayon fibers. The high-loft web structure fire blocking layer 100, as illustrated in this figure, is the preferred vertically stacked structure comprising a plurality of continuous alternating peaks and valleys as previously discussed. The thermoplastic batting material 130 is typically a “slickened” or “non-slickened” polyester high loft polyester batting. The foam 140 is typically a polyurethane foam. The scrim cloth 150 is generally a layer of a 0.5-1 oz/yd² nonwoven (generally spunbonded) fabric.

The layers of the mattress quilt panel 11 can be securely bound together by lines of stitching 16 with thread. The stitching extends through the layers of the composite layered structure and the stitches are preferably configured in a quilted pattern defining contiguous regions 17. The stitching is preferably sewn with a tension sufficient to collapse the vertically-stacked high-loft fire blocking layer between the layers 120 and 130 along the lines of stitching as illustrated at 18. However, if greater spacing between layers 120 and 130 along the lines of stitching is desired, the sewing tension can be reduced to create looser stitches and thus avoiding total collapse of the vertically-stacked high-loft fire blocking layer.

The stitching 16 functions to maintain the vertically stacked structure intermediate layer 100 securely in position between the ticking 120 and the remaining components. The quilted stitching pattern thus preserves the integrity of the pleats formed in the vertically stacked layer material so that the spacing between the ticking and inner layers and the air pockets and spacing defined therebetween are maintained throughout normal use and cleaning conditions. In this way, the composite structure retains its performance qualities even after long use of a mattress. If additional fire protection is desired, the ticking, batting, foam, and/or scrim cloth can be made from material having fire blocking qualities of its own.

The high-loft web structure of this invention can be incorporated mattresses, foundations, and/or box springs as a fire blocking layer. For example, the panels and the borders of mattresses, foundations, and/or box springs can utilize the previously described mattress panel quilt or any other variant that incorporates as a component a high loft web structure of this invention. The stitching can be sewn with non-fire retardant thread, however, a fire-retardant thread, such as one made from Kevlar® aramid fiber, is preferred for the stitching, especially for stitching of the borders of the mattresses, foundations, and/or box springs.

Process for Fire Blocking a Mattress

This invention further relates to a process for fireblocking a mattress, comprising incorporating into a mattress a high loft web structure, the web structure comprising 1 to 20 parts by weight p-aramid fibers, 20 to 60 parts by weight regenerated cellulosic fiber that retains at least 10 percent of its fiber weight when heated in air to 700° C. at a rate of 20 degrees C. per minute, 10 to 60 parts by weight polyester fibers, and up to 20 parts by weight binder material wherein the total of (a), (b), (c) and (d) is on a basis of 100 parts by weight. Preferably, the binder material is a binder fiber and the high-loft web structure has an areal density in a range from 100 to 510 grams/square meter (3 to 15 ounces/square yard) and an average height in a range from 0.64 to 5.1 centimeters (0.25 to 2 inches).

The high-loft web structure of the present invention can also be used to fire block other articles, such as sleeping bags, cushion seats, transportation seating, insulated garments, filter media, insulating curtains, wall coverings, upholstered furniture or any end use application where a high loft, nonwoven material is desired. The high-loft web structure of this invention can be used as either a single layer, or plural layers of web structure may be used, depending on the desired properties of the final article.

To further illustrate the present invention, the following examples are provided. All parts and percentages are by weight unless otherwise indicated.

### Test Methods

Flame Barrier Testing. The high loft web structures were tested using Technical Bulletin 117 (Draft February 2002) entitled “Requirements, Test Procedure and Apparatus for Testing the Flame and Smolder Resistance of Upholstered Furniture” of the State of California Department of Consumer Affairs. The horizontal test apparatus for fiber battings and loose-fill materials as disclosed in Annex C was used.

ThermoGravametric Analysis. The cellulose fibers used in this invention retain a portion of their fiber weight when heated to high temperature at a specific heating rate. This fiber weight was measured using a Model 2950 Thermogravimetric Analyzer (TGA) available from TA Instruments (a division of Waters Corporation) of Newark, Del. The TGA gives a scan of sample weight loss versus increasing temperature. Using the TA Universal Analysis program, percent weight loss can be measured at any recorded temperature. The program profile consists of equilibrating the sample at 50 degrees C.; ramping the temperature at from 10 or 20 degrees C. per minute from 50 to 1000 degrees C.; using air as the gas, supplied at 10 ml/minute; and using a 500 microliter ceramic cup (PN 952018.910) sample container.

The testing procedure is as follows. The TGA was programmed using the TGA screen on the TA Systems 2900 Controller. The sample ID was entered and the planned temperature ramp program of 20 degrees per minute selected. The empty sample cup was tared using the tare function of the instrument. The fiber sample was cut into approximately 1/16″ (0.16 cm) lengths and the sample pan was loosely filled with the sample. The sample weight should be in the range of 10 to 50 mg. The TGA has a balance therefore, the exact weight does not have to be determined beforehand. None of the sample should be outside the pan. The filled sample pan was loaded onto the balance wire making sure the thermocouple is close to the top edge of the pan but not touching it. The furnace is raised over the pan and the TGA is started. Once the program is complete, the TGA will automatically lower the furnace, remove the sample pan, and go into a cool down mode. The TA Systems 2900 Universal Analysis program is then used to analyze and produce the TGA scan for percent weight loss over the range of temperatures.

Mattress Burn Performance. The Bureau of Home Furnishings and Thermal Insulation of the Department of Consumer Affairs of the State of California (3485 Orange Grove Avenue, North Highlands, Calif. 95660-5595, USA) published Technical Bulletin 603 “Requirements and Test Procedure for Resistance of a Residential Mattress/Box Spring Set to a Large Open-Flame” dated February 2003 to quantify the flammability performance of mattress sets. The bulletin was later revised in July 2003, requiring the limit of Peak Heat Release Rate (PHRR) to be less than 200 kilowatts and the Total Heat release limit at 10 minutes to be less than 25 megajoules. This protocol provides a means of determining the burning behavior of mattress/foundation sets by measuring specific fire test responses when the mattress plus foundation are exposed to a specified flaming ignition source under well-ventilated conditions. It is based on the National Institute of Standards and Technology Publication titled “Protocol of Testing Mattress/Foundation Sets Using a Pair of Gas Burners” dated February 2003.

Test data are obtained that describe the burning during and subsequent to the application of a specific pair of gas burners from the point of ignition until (1) all burning of the sleep set has stopped, (2) a period of 30 minutes has elapsed, or (3) flashover of the test room appears inevitable. The rate of heat release from the burning test specimen (the energy generated by the fire) is measured by oxygen consumption calorimetry. A discussion of the principles, limitations, and requisite instrumentation are found in ASTM E 1590 “Standard Test Method of Fire Testing of Mattresses”. Terminology associated with the testing is defined in ASTM E 176 “Standard Terminology of Fire Standards”.

In general, the test protocol utilizes a pair of propane burners, designed to mimic the heat flux levels and durations imposed on a mattress and foundation by burning bedclothes. The burners impose differing fluxes for differing times on the mattress top and the side of the mattress/foundation. During and subsequent to this exposure, measurements are made of the time-dependent heat release rate from the test specimen.

The mattress/foundation is placed on top of a short bed frame that sits on a catch surface. During the testing, the smoke plume is caught by a hood that is instrumented to measure heat release rate. For practicality, twin-sized mattresses and foundations are tested. After ignition by the burners, the specimen is allowed to burn freely under well-ventilated conditions.

The test specimen includes a mattress that is placed on foundation with T-shaped burners set to burn the specimen. One burner impinges flames on the top surface of the mattress and is set 39 mm from the surface of the mattress. The second burner impinges flames vertically on the side of the mattress/foundation combination and is set 42 mm from the side of the specimen. The side burner and the top burner are not set at the same place along the length of the specimen but are offset from on another along the length approximately 18 to 20 cm. The burners are specially constructed and aligned per the test method.

The test specimen is conditioned for 24 hours prior to the testing at an ambient temperature of above 12 Celsius (54 Fahrenheit) and a relative humidity of less than 70 percent. The test specimen of mattress and foundation is centered on each other and the frame and catch surface. If the mattress is 1 to 2 cm narrower than the foundation the mattress may be shifted until the sides of the mattress and foundation are aligned vertically. The burners are aligned and spaced from the specimen per the standard. Data recording and logging devices are turned on at least one minute prior to ignition. The burners are ignited and the top burner is allowed to burn for 70 seconds while the side burner is allowed to burn for 50 seconds (if possible) and then they are removed from the area. Data collection continues until all signs of burning and smoldering have ceased or until one hour has elapsed.

### EXAMPLES

### Example 1

Staple fiber from bales were fed to a picker. The fiber blend consisted of the following components: (i) Kevlar® Type 970 (2.25 dpf, 1.9 inch cut length; (ii) Nomex® Type 450 (1.5 dpf, 1.5 inch cut length), and (iii) VISIL® (Type 33AP) (1.5 dpf, 1.6-inch cut length); (iv) Poly(ethylene terephthalate) Type 808 (6.5 dpf, 1.5-inch cut length) and (v) Unitika binder fiber MELTY 4080 Type S74 (4.0 dpf, 1 inch cut length). The relative concentration by weight was 18% Kevlar® p-aramid, 13% Nomex® m-aramid, 37% VISIL®, 14% PET, and 18% binder fiber. The opened-up fiber mixture was well blended in an air-conveyed blender to form a uniform mixture. The well-blended fiber mixture was carded to form a fibrous web. The well-blended, uniform card web was then converted into the vertically stacked structure comprising a plurality of continuous alternating peaks and valleys, as disclosed in U.S. Pat. No. 6,602,581. The accordion-like arrangement of the structure which extends in alternately different directions between each peak and each valley was formed by the driving mechanism reciprocating element, moving up and down vertically at a frequency of 700 strokes per minute. The vertically folded structure immediately entered into an oven maintained at 375° F. to bond and consolidate the structure to maintain its vertical stacking. The structure height was 0.8 inch, with an areal density of 7 oz/yd² and a peak frequency of 37 peaks/foot.

A 12″×12″ sample of the structure was evaluated for flame barrier performance using Cal 117 draft standard (2002) test. The test specimen was arranged horizontally on a frame and a 1 1/2 inch methane gas flame was centered ¾″ underneath the sample for a period of 20 seconds. The structure passed the test.

### Comparative Example

Two prior art items were also evaluated using Cal 117 draft standard (2002) test:

Item A consisted of a spunlaced product Type E-89, available from DuPont, containing 66% Nomex® and 34% Kevlar®. The nonwoven material had an areal density of 2.5 oz/yd² and 0.03 inches thick. This item did not pass the Cal 117 test.

Item B consisted of vertically folded structure made substantially the same as Example 1 except having a PET-rich composition. The fiber blend consisted of 85% PET, 5% Kevlar® and 10% binder of height 0.975″ and areal density of 4.1 oz/yd². This item failed the Cal 117 test.

### Example 2

Vertically folded structures were made substantially the same as in Example 1 except with varying composition, height and areal density, shown in Table 1. The structures are evaluated for flame barrier performance using Cal 117 draft standard (2002) test. The structures passed the test.

TABLE 1

| Item | HT | AD | K % | N % | V % | M % | P % | Binder % |
|---|---|---|---|---|---|---|---|---|
| 1 | 0.80 | 7.0 | 5 | 0 | 40 | 0 | 35 | 20 |
| 2 | 0.80 | 7.0 | 5 | 0 | 60 | 0 | 15 | 20 |
| 3 | 0.50 | 7.0 | 5 | 0 | 40 | 0 | 45 | 10 |
| 4 | 0.80 | 9.0 | 18 | 13 | 37 | 0 | 14 | 18 |
| 5 | 1.00 | 9.0 | 18 | 13 | 37 | 0 | 14 | 18 |
| 6 | 0.93 | 3.4 | 13 | 0 | 20 | 0 | 57 | 10 |
| 7 | 0.58 | 3.1 | 5 | 8 | 20 | 0 | 57 | 10 |
| 8 | 1.06 | 5.6 | 20 | 0 | 40 | 0 | 30 | 10 |
| 9 | 0.65 | 4.7 | 5 | 0 | 40 | 0 | 45 | 10 |
| 10 | 0.59 | 3.4 | 5 | 8 | 40 | 0 | 38 | 10 |
| 11 | 0.98 | 5.0 | 5 | 15 | 40 | 0 | 30 | 10 |
| 12 | 0.62 | 5.2 | 5 | 0 | 20 | 20 | 45 | 10 |
| 13 | 0.61 | 3.2 | 5 | 0 | 40 | 20 | 25 | 10 |
| 14 | 0.70 | 4.0 | 5 | 8 | 40 | 20 | 17 | 10 |

HT = Height in inches
AD = Areal Density oz/yd²
K = Kevlar ® para-aramid fiber
N = Nomex ® meta-aramid fiber
V = Visil ® fiber
M = modacrylic fiber
P = polyethylene terephthalate fiber
Binder = polyester low melt fibers

### Example 3

A sleep set comprising a mattress and foundation were made using typical mattress and foundation construction techniques with a fire blocking high-loft web structure used to protect the mattress panel, the high-loft web structure comprising (i) Kevlar® Type 970 (2.25 dpf, 1.9 inch cut length; (ii) Nomex® Type 450 (1.5 dpf, 2 inch cut length), and (iii) VISIL® (Type 33AP) (1.5 dpf, 1.6-inch cut length); (iv) Poly(ethylene terephthalate) Type 808 (6.5 dpf, 1.5-inch cut length) and (v) Unitika binder fiber MELTY 4080 Type S74 (4.0 dpf, 1-inch cut length). The relative concentration by weight is 18% Kevlar® p-aramid, 13% Nomex® m-paramid, 37% VISIL®, 14% PET and 18% binder fiber. The opened-up fiber mixture was well blended in an air-conveyed blender to form a uniform mixture. The well-blended fiber mixture was carded to form a fibrous web. The well-blended, uniform carded web was then converted into the vertically stacked structure comprising a plurality of continuous alternating peaks and valleys of the present invention. The accordion-like arrangement of the structure which extends in alternately different directions between each peak and each valley was formed by the driving mechanism reciprocating element, moving up and down vertically at a frequency of 700 strokes per minute. The vertically folded structure immediately entered into an oven maintained at 375° F. to bond and consolidate the structure to maintain its vertical stacking. The structure height was 0.8 inch, with an areal density of 7 oz/yd² and a peak frequency of 37 peaks/foot.

The mattress core was a standard steel coil construction covered with a fiber pad and a 0.5-inch (1.25 centimeter) foam sheet. The foundation consisted of a wood box construction. The mattress was a single-sided tight (smooth) top style. The mattress borders used the same barrier sheet as the mattress panel.

The panel material for the mattresses was assembled by quilting together with standard polyester thread the following components in the order: 3.5 oz/yd² woven polyester ticking fabric, a single layer of the high-loft fire blocking web structure described above, approximately 1″ polyester batting having an arial density of 0.75 oz/yd², ⅞″ polyurethane foam sheet, 7/16″ polyurethane foam sheet, and a nonwoven backing sheet of approximately 0.5 oz/yd². The panel material was used to cover the top side of the mattress. The bottom side was covered with a sheet barrier composed of Kevlar® 25%, Visil® 75%.

Border material was assembled in a separate operation by quilting together with standard polyester thread the following components in the order: 3.5 oz/yd² woven polyester ticking fabric, the same fire-blocking structure described above, 3/16″ polyurethane foam, and a nonwoven backing sheet of approximately 0.5 oz/yd². The border material was used to cover all vertical sides of the mattresses.

The border material was also used on the vertical sides of the foundation employing a 2-inch (5.1 centimeter) continental or waterfall design on the upper edge of the foundation, a design in which the border material is folded over the upper edge and extends onto the foundation top panel.

The foundation top panel area was covered with a 4 oz/yd² (136 g/m²) of spunlaced nonwoven fabric (having a composition of 25% Kevlar® and 75% Visil®) under a standard non-skid pad. All border and panel composite material seams were sewn with a thread containing Kevlar® fiber. FR-treated polyester seam tape was also used throughout.

The sleep set was individually burned according to Technical Bulletin 603 of the State of California. The top panel of the mattress self-extinguished and the Peak Heat Release Rate of all was less than 100 kilowatts during the test (60 min. max.) with a Total Heat Release of less than 25 mega joules in the first 10 minutes.

1. A fiber composition useful for fire blocking, comprising:
(a) 1 to 20 parts by weight p-aramid fibers,
(b) 20 to 60 parts by weight regenerated cellulose fibers containing silicic acid,
(c) 10 to 60 parts by weight polyester fibers, and
(d) up to 20 parts by weight binder material,
wherein the total of (a), (b), (c) and (d) is on a basis of 100 parts by weight.

2. The fiber composition of claim 1 additionally containing m-aramid fibers in an amount up to 20 parts by weight.

3. The fiber composition of claim 1 additionally containing modacrylic fibers in an amount up to 20 parts by weight.

4. The fiber composition of claim 3 wherein the modacrylic fiber contains an antimony compound.

5. The fiber composition of claim 1 wherein the p-aramid is poly(p-phenylene terephthalate).

6. The fiber composition of claim 1 wherein the binder material is a binder fiber.

7. A high loft web structure useful for fire blocking, comprising:
(a) 1 to 20 parts by weight p-aramid fibers,
(b) 20 to 60 parts by weight regenerated cellulosic fiber that retains at least 10 percent of its fiber weight when heated in air to 700° C. at a rate of 20 degrees C. per minute,
(c) 10 to 60 parts by weight polyester fibers, and
(d) up to 20 parts by weight binder material,
wherein the total of (a), (b), (c) and (d) is on a basis of 100 parts by weight.

8. The high loft web structure of claim 7 wherein the regenerated cellulosic fiber contains silicic acid.

9. The high loft web structure of claim 7 additionally containing m-aramid fibers in an amount up to 20 parts by weight.

10. The high loft web structure of claim 7 additionally containing modacrylic fibers in an amount up to 20 parts by weight.

11. The high loft web structure of claim 7 wherein the modacrylic fiber contains an antimony compound.

12. The high loft web structure of claim 7 wherein the p-aramid is poly(p-phenylene terephthalate).

13. The high loft web structure of claim 7 in the form of a structure having an areal density in a range from 100 to 510 grams/square meter (3 to 15 ounces/square yard) and an average height in a range from 0.64 to 5.1 centimeters (0.25 to 2 inches).

14. The high loft web structure of claim 13 wherein the structure has an areal density of from 170 to 340 g/m² (5 to 10 oz/yd²), and an average height or thickness of 0.64 to 2.54 cm (0.25 to 1 inches).

15. The high loft web structure of claim 7 wherein the binder material is a binder fiber.

16. The high loft web structure of claim 7 in the form of a structure having a lengthwise rectangular cross section with parallel ridges and grooves.

17. The high loft web structure of claim 16 in the form of a structure having equal spacing between ridges and grooves.

18. An article comprising the high loft web structure of claim 7, which when tested in accordance with California 117 draft standard (2002), passes that standard.

19. A process for making a high-loft web structure, comprising:
(a) forming a mixture of 1 to 20 parts by weight p-aramid fiber, 20 to 60 parts by weight regenerated cellulosic fiber that retains at least 10 percent of its fiber weight when heated in air to 700° C. at a rate of 20 degrees C. per minute, 10 to 60 parts by weight polyester fiber, and up to 20 parts by weight binder material, wherein the total of these fibers and binder material is on a basis of 100 parts by weight,
(b) blending the mixture to form a uniform fiber composition,
(c) carding the uniform fiber composition to form a web,
(d) converting the web into a high loft web structure having a lengthwise rectangular cross section with parallel ridges and grooves, and
(e) activating the binder material with heat to set the high loft web structure.

20. The process of claim 19 wherein the binder material is a binder fiber.

21. A process for making a high-loft web structure, comprising:
(a) forming a mixture of 1 to 20 parts by weight p-aramid fiber, 20 to 60 parts by weight regenerated cellulosic fiber that retains at least 10 percent of its fiber weight when heated in air to 700° C. at a rate of 20 degrees C. per minute, and 10 to 60 parts by weight polyester fiber,
(b) blending the mixture to form a uniform fiber composition,
(c) carding the uniform fiber composition to form a web,
(d) contacting the web with up to 20 parts by weight a binder material,
(e) converting the web into a high loft web structure having a lengthwise rectangular cross section with parallel ridges and grooves, and
(f) activating the binder material with heat to set the high loft web structure,
wherein the total of the fibers and binder material is on a basis of 100 parts by weight.

22. The process of making a high-loft web structure of claim 21 wherein the binder material is a powder.

23. The process of making a high-loft web structure of claim 21 wherein the binder material is a liquid.

24. A fireblocked mattress, comprising as one component of the mattress a high loft web structure, the web structure comprising:
(a) 1 to 20 parts by weight p-aramid fiber,
(b) 20 to 60 parts by weight regenerated cellulosic fiber that retains at least 10 percent of its fiber weight when heated in air to 700° C. at a rate of 20 degrees C. per minute,
(c) 10 to 60 parts by weight polyester fiber, and
(d) up to 20 parts by weight binder material
(e) wherein the total of (a), (b), (c) and (d) is on a basis of 100 parts by weight.

25. The fireblocked mattress of claim 24 wherein the high loft web structure has an areal density in a range from 100 to 510 grams/square meter (3 to 15 ounces/square yard) and an average height in a range from 0.64 to 5.1 centimeters (0.25 to 2 inches).

26. The fireblocked mattress of claim 25 wherein the structure has an areal density of from 170 to 340 g/m² (5 to 10 oz/yd²), and an average height or thickness of 0.64 to 2.54 cm (0.25 to 1 inches).

27. The fireblocked mattress of claim 24 wherein the web structure is in the form of a structure having a lengthwise rectangular cross section with parallel ridges and grooves.

28. The fireblocked mattress of claim 27 wherein the web structure is in the form of a structure having equal spacing between ridges and grooves.

29. A process for fireblocking a mattress, comprising incorporating into a mattress a high loft web structure, the web structure comprising:
(a) 1 to 20 parts by weight p-aramid fibers,
(b) 20 to 60 parts by weight regenerated cellulosic fiber that retains at least 10 percent of its fiber weight when heated in air to 700° C. at a rate of 20 degrees C. per minute,
(c) 10 to 60 parts by weight polyester fibers, and
(d) up to 20 parts by weight binder material
wherein the total of (a), (b), (c) and (d) is on a basis of 100 parts by weight.

30. The process for fireblocking a mattress of claim 29 wherein the web structure has an areal density in a range from 100 to 510 grams/square meter (3 to 15 ounces/square yard) and an average height in a range from 0.64 to 5.1 centimeters (0.25 to 2 inches).

31. The process for fireblocking a mattress of claim 30 wherein the web structure has an areal density in a range from 170 to 340 g/m² (5 to 10 oz/yd²), and an average height or thickness of 0.64 to 2.54 cm (0.25 to 1 inches).

32. The process for fireblocking a mattress of claim 30 wherein the binder material is a binder fiber.
